(19) United States
(12) Patent Application Publication
(10) Pub. No.: US 2005/0168353 A1
(43) Pub. Date: Aug. 4, 2005

(54) User interface for defining geographic zones for tracking mobile telemetry devices

(75) Inventors: James F. Dement, Brandon, MS (US); Jie Zou, Brandon, MS (US)

Correspondence Address: MCI, INC;TECHNOLOGY LAW DEPARTMENT, 1133 19TH STREET NW, 10TH FLOOR, WASHINGTON, DC, 20036, US

(73) Assignee: MCI, Inc., Ashburn, VA (US)

(21) Appl. No.: 11/089,651

(22) Filed: Mar. 25, 2005

Related U.S. Application Data
(63) Continuation-in-part of application No. 10/758,930, filed on Jan. 16, 2004.

(51) Int. Cl. G08G 1/123

(52) U.S. Cl. 340/995.1

(57) ABSTRACT

An approach is provided for tracking a vehicle via a web interface. A graphical user interface (GUI) screen includes a map showing an icon representing position of the vehicle. A zoom area is established over the map according to a rubber-band mechanism utilized by a user.

### RELATED APPLICATIONS

The present application is a Continuation-In-Part of U.S. patent application Ser. No. 10/758,930 filed Jan. 16, 2004, entitled “Method and System for Interfacing with Mobile Telemetry Devices”; the contents of which are hereby incorporated by reference.

### FIELD OF THE INVENTION

The present invention relates to data communications, and more particularly, to interfacing with mobile telemetry devices for fleet and asset management.

### BACKGROUND OF THE INVENTION

Modern wireless networks, such as paging systems, can readily be configured to offer a variety of telemetry services, notably fleet and asset management. The management of vehicles within a fleet as well as assets involves obtaining information, generally in real-time, about the location and movement of these objects. The fleet manager utilizes this information to maximize use of fleet resources. With the advent of the Global Positioning System (GPS) supported by a constellation of satellites, a vehicle may determine its location with great accuracy and convenience if no obstruction exists between the GPS receiver within the vehicle and the satellites. Additionally, in recognition of the utility of real-time location of vehicles, governmental bodies have begun to impose strict requirements for determining position information of emergency 911 callers. Therefore, with the impetus stemming from competitive and regulatory forces, service providers seek to offer an efficient, cost-effective fleet and asset management service with robust capability by effectively integrating GPS technology with wireless networks so as to minimize bandwidth in the exchange of telemetry data.

FIG. 17 shows a diagram of a conventional wireless network in an autonomous GPS environment. As shown, a wireless network 1701 communicates with vehicles 1703 to track the location of these vehicles 1703 within the coverage area of the wireless network 1701. Each of the vehicles 1703 employ a GPS device 1705 that communicates with a constellation of satellites 1707. These satellites 1707 transmit very low power interference and jamming resistant signals received by the GPS receivers 1705. At any point on Earth, a GPS device 1705 is able to receive signals from multiple satellites.

Specifically, a GPS device 1705 may determine three-dimensional geolocation from signals obtained from at least four satellites. Measurements from satellite tracking and monitoring stations located around the world are incorporated into orbital models for each satellite to compute precise orbital or clock data. GPS signals are transmitted over two spread spectrum microwave carrier signals that are shared by all of the GPS satellites 1707. The device 1705 must be able to identify the signals from at least four satellites 1707, decode the ephemeris and clock data, determine the pseudo range for each satellite 1707, and compute the position of the receiving antenna. The time required to acquire a position depends on several factors including the number of receiving channels, processing power of the receiving device, and strength of the satellite signals.

The above arrangement, as an autonomous GPS environment, has a number of drawbacks that can hinder its effectiveness as a fleet management system. Because the GPS device 1705 must obtain all of the ephemeris data from the satellite signals, weak signals can be problematic. A building location or a location in any area that does not have clear view of the satellite constellation 1707 can prevent the GPS device 1705 from determining its geolocation. Also, cold start acquisition may consume a few seconds to as much as a few minutes, which is a significant delay for the device's ability to log positional information and evaluate its position against pre-configured alert conditions.

The vehicles 1703 then need to transmit the location information to the wireless network 1701. These transmissions can consume large amounts of bandwidth of the wireless network 1701 if the location information is continually transmitted without attention to the polling scheme and the underlying transmission protocol used to transport such data. Additionally, a user interfacing with the device remotely may request information that may require significant download time for response, e.g., if the user is requesting the information via a web browser through, e.g., the Internet (e.g., the response to the request may involve an extremely large amount of data). An exemplary user may desire a display of a graphical map of the area currently surrounding the location of the device. Additionally, the user may desire that the display include a graphical indicator to indicate the current position or a status associated with the device. Also, the user may desire a display to enable the user to configure the device, control an entity associated with the device (e.g., a vehicle, or a fleet of vehicles for multiple devices) or to request and receive reports of the device status, or to graphically handle management issues related to the device.

An amount of information needed for such graphical display may involve transmission of very large amounts of data for handling at the user's machine, as well as massive programming efforts to implement code for handling various types of requests that the user may make. If a user has to wait several minutes for download of the data required for a graphical map screen to be painted on his/her display device, the user may become frustrated, or may be unable to quickly respond, e.g., to a time-critical need that may be indicated by information communicated by the device. Additionally, a user may not wish to expend resources on programmer time and effort, and storage capacity, to support overwhelming amounts of code for implementation of various features for a graphical interface.

Furthermore, conventional tracking systems have focused primarily on industrial applications, largely because of costs and inflexibility of such systems. For example, the user software for interfacing the tracking system requires customized interfaces, resulting in high development costs. Additionally, these interfaces require a trained operator. The devices to be tracked are functionally constrained in terms of the types of data that can be collected, thereby limiting the types of services that can be created for non-industrial use.

Therefore, there is a need for a user interface, for a tracking system, that is easy-to-use and inexpensive. There is also a need for a tracking system that is reliable and robust as to permit development of new applications and services.

### SUMMARY OF THE INVENTION

These and other needs are addressed by the present invention, in which an approach for tracking mobile telemetry devices over a two-way wireless network in support of a supervisory or parental control service is provided.

According to one aspect of the present invention, a method of tracking a vehicle via a web interface is disclosed. The method includes displaying via the web interface a graphical user interface (GUI) screen including a map showing an icon representing position of the vehicle. The method also includes establishing a zoom area over the map according to a rubber-band mechanism utilized by a user.

According to another aspect of the present invention, an apparatus for communicating with a tracking system is disclosed. The apparatus includes a communication interface configured to communicate with a web server storing telemetry data of a vehicle monitored by the tracking system, wherein the telemetry data includes position of the vehicle. The apparatus also includes a display configured to display a graphical user interface (GUI) screen including a map showing an icon representing the position of the vehicle. The apparatus further includes a cursor control mechanism controlled by a user and configured to establish a zoom area over the map according to a rubber-band mechanism.

According to yet another aspect of the present invention, an apparatus for supporting tracking of an object associated with a telemetry device is disclosed. The apparatus includes means for transmitting display information for displaying interactive elements on a display device, wherein the display device is configured to display a map indicating a location of a tracked object. The apparatus also includes means for receiving, from a user, information associated with status of the tracked object. Further, the apparatus includes means for transmitting, to the telemetry device, the status information.

Still other aspects, features, and advantages consistent with the present invention are readily apparent from the following detailed description, simply by illustrating a number of particular embodiments and implementations, including the best mode contemplated for carrying out the present invention. Methods, systems, and articles of manufacture consistent with the present invention are also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a fleet and asset tracking system, according to an embodiment of the present invention;

FIG. 2 is a diagram of a telemetry device used in the system of FIG. 1, according to an embodiment of the present invention;

FIG. 3 is a diagram of a Network Operations Center (NOC) in the system of FIG. 1, according to an embodiment of the present invention;

FIG. 4 is a diagram of the formats of protocol messages used in the system of FIG. 1;

FIG. 5 is a diagram of the format of a Wireless Protocol (WP) message used in the system of FIG. 1;

FIG. 6 is a diagram of the format of a batched Wireless Protocol (WP) message used in the system of FIG. 1;

FIG. 7 is a diagram of a Network Operations Center (NOC) in the system of FIG. 1, according to an embodiment of the present invention;

FIG. 8 is a diagram of a fleet and asset management system with end-to-end encryption, according to an embodiment of the present invention;

FIG. 9 is a diagram of a fleet and asset management system with end-to-end encryption in an enterprise environment, according to an embodiment of the present invention;

FIG. 10 is a diagram of the telemetry device of FIG. 2a deployed within the vehicle, according to an embodiment of the present invention;

FIG. 11 is a flowchart of a process for supporting supervisory or parental control via a web interface, according to an embodiment of the present invention;

FIG. 12 is a graphical screen displaying locations visited by a tracked vehicle, according to an embodiment of the present invention;

FIG. 13 is a graphical screen for viewing details of a location visited by the vehicle, according to an embodiment of the present invention;

FIG. 14 is a graphical screen for viewing and creation of geographic zones, according to an embodiment of the present invention;

FIG. 15 is a graphical screen providing a rubber-band zoom capability, according to an embodiment of the present invention;

FIG. 16 is a diagram of a computer system that can be used to implement an embodiment of the present invention; and

FIG. 17 is a diagram of a conventional wireless network in an autonomous GPS environment.

### DESCRIPTION OF THE PREFERRED EMBODIMENT

A system, method, and software for timely and prioritized communication of information from a mobile telemetry device are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

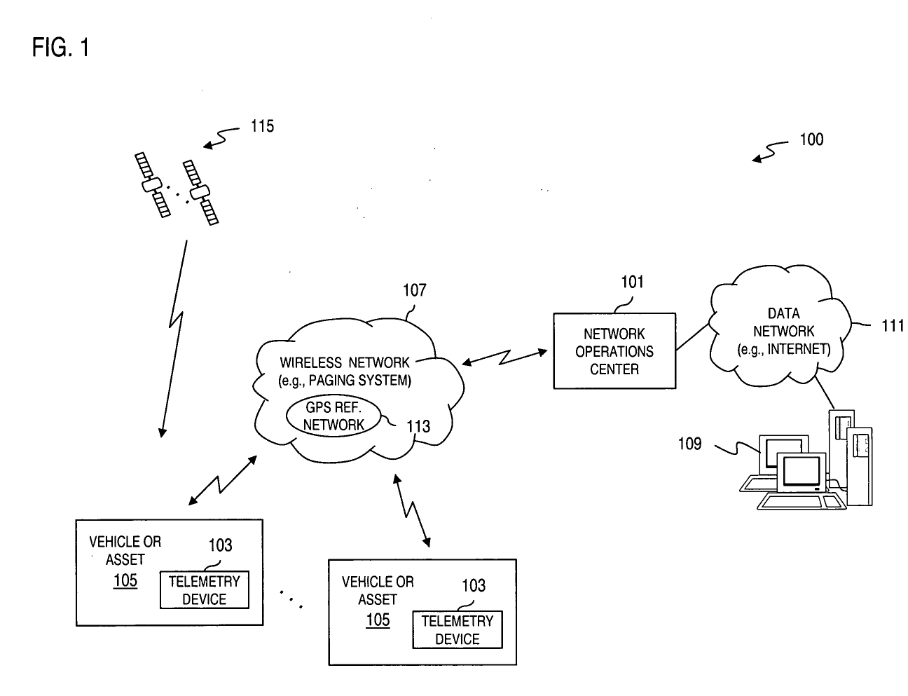

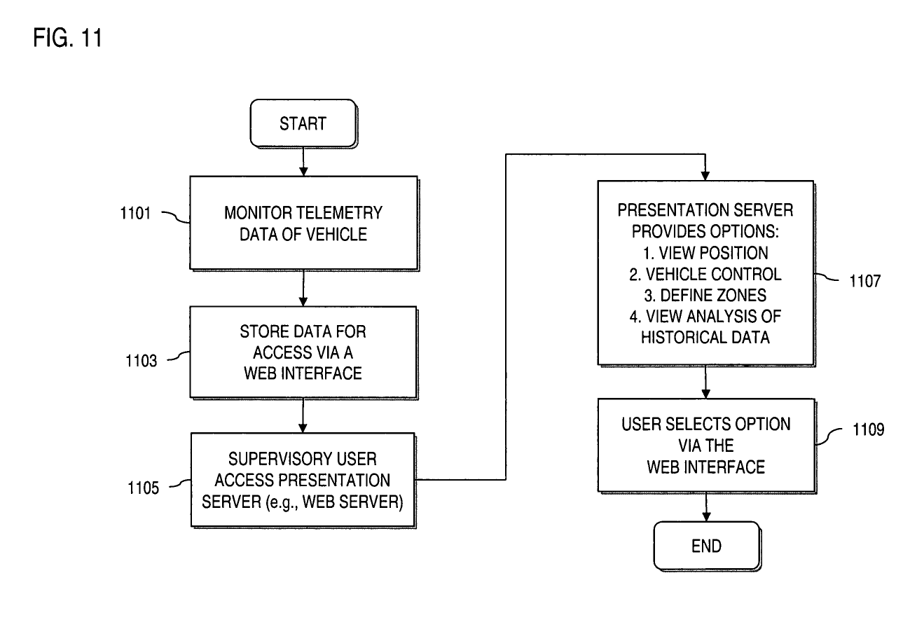

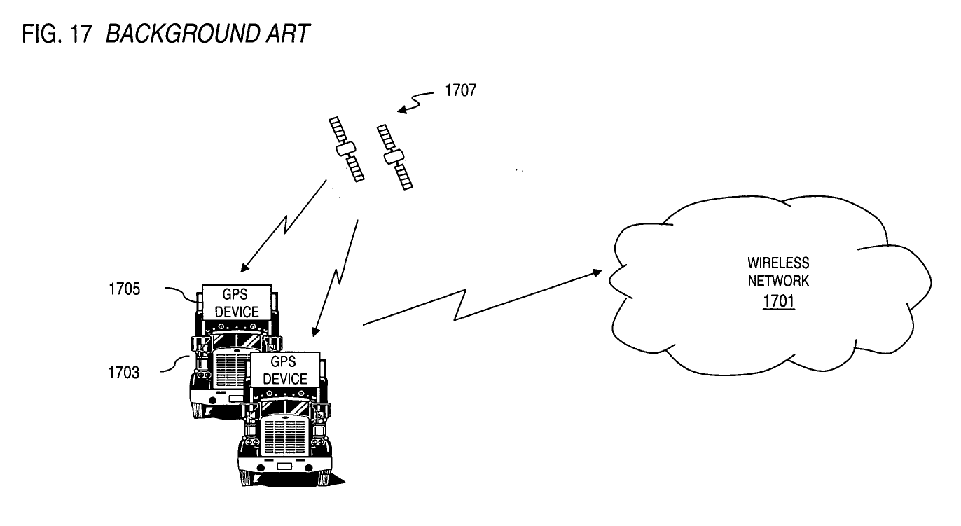

FIG. 1 shows a diagram of a fleet and asset tracking system, according to an embodiment of the present invention. The system 100, in contrast to the system of FIG. 17, utilizes a combination of autonomous GPS and Assisted GPS (A-GPS); in particular, mobile-centric A-GPS. The system 100 includes a Network Operation Center (NOC) 101 for tracking telemetry devices 103, which, under this scenario, are resident within vehicles 105. It is contemplated that the telemetry device 103 can be affixed to an asset (or any other object). In addition to industrial applications, the system 100 can provide a supervisory or parental control service, whereby a teenage driver can be monitored in terms of their driving habits and visited destinations. This service is more fully described later with respect to FIGS. 11-15.

A wireless network 107 supports two-way communication among the telemetry devices 103 and the NOC 101; the wireless network 107, in an exemplary embodiment, is a two-way paging system employing the ReFLEX™ protocol by Motorola for two-way advanced messaging. The telemetry devices 103 have two modes of operation: autonomous GPS mode, and A-GPS mode. When operating in A-GPS mode, the system 100 can provide for better in building or obstructed view geolocation within a paging system zone. When out of network coverage, the autonomous GPS may be used to obtain geolocation data that may be stored on the device for later transmission.

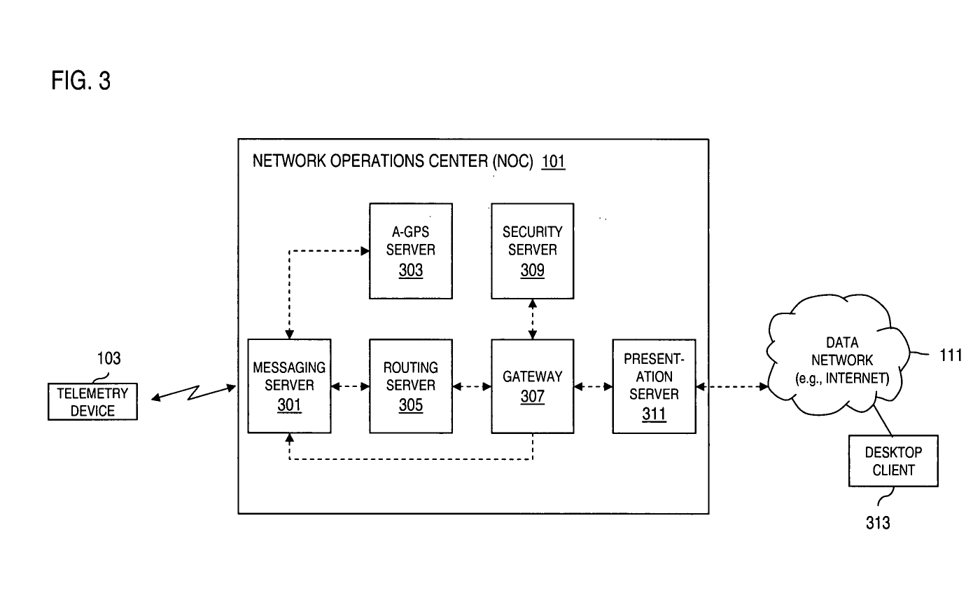

The NOC 101 provides the necessary fleet and asset management functions, such as user account creation and management, access control, and deployment of business rules; these functions are more fully described below with respect to FIG. 3. The NOC 101 also supports remote management capabilities by hosts 109 over a data network 111, such as the global Internet.

To better understand the hybrid A-GPS environment of the system 100, it is instructive to describe the operation of the general operation of a mobile-centric A-GPS system. The telemetry device 103 has GPS hardware and intelligence relative to the autonomous GPS scenario, whereby the network 107 in conjunction with the NOC 101 employs mechanisms for providing GPS aiding data (or assistance data). The network 107 includes base transmitters and some base receivers containing GPS hardware from which the ephemeris and approximate location can be obtained, constituting a GPS reference network 113.

The assistance data that is transmitted to the devices 103, in an exemplary embodiment, can include ephemeris data differential GPS correct data, timing data and/or other aiding data. Using the aiding (or assistance) data, the telemetry devices 103 performs geolocation calculations, yielding a number of advantages. For example, the telemetry devices 103 can generate real-time speed and route adherence alerts. Additionally, transmission of geolocation data need not be frequent. Transmission of geolocation data is more compact because it is true location rather than pseudo range data. Also, the telemetry devices 103 can more intelligently request assistance data because the devices 103 themselves can determine when the ephemeris data is no longer valid.

The hybrid A-GPS system 100 thus permits fast and precise geolocation when in network coverage of the network 101, while providing immunity from obstructed view of the sky. Also, when the switch is made to autonomous GPS mode (when outside of the coverage area of the network 101), the devices 103 can still obtain geolocation data. This data can be stored within the device 103 and transmitted to the NOC 101 when the associated vehicle 105 returns to the network coverage area.

As noted earlier, the telemetry devices 103 may be attached to a host entity such as a vehicle or other valuable asset. The device may be used to track, monitor, and control aspects of the host entity. These devices 103 are configurable with respect to the existence and number of digital inputs/outputs (I/O), analog inputs/outputs (I/O), and device port interfaces for connection with peripheral devices. By way of example, the digital inputs can be used to monitor various components of the vehicles 105: ignition status, door lock status, generic switch status, headlight status, and seat occupancy status. The digital outputs can be used to control, for example, the starter, and door locks, and to monitor such parameters as engine temperature, cargo temperature, oil pressure, fuel level, ambient temperature, and battery voltage. The exact configuration of the telemetry devices 103 can be based on cost consideration and/or applications.

The telemetry devices 103, in an exemplary embodiment, employ a wireless protocol to receive commands and transmit data and alerts (e.g., high speed alert) over the radio network 107. The telemetry devices 103 can queue alerts, message responses, and scheduled data, whereby if the devices 103 are unable to send the messages, the messages are queued and sent when the device 103 returns to wireless network coverage. Prioritized queues are used and include, for example, queues for high, normal, and low priority messages. In the exemplary implementation, critical device status changes are given highest priority, while other alerts and responses are given normal priority. Scheduled data messages are given the lowest priority. The queues are configured, as first in yields first out, wherein new messages are dropped when its corresponding queue is full. This arrangement advantageously allows for the status of the device 103 at the time of transmission failure to be known even when the data stored in the data log at time of the transmission has been overwritten.

The telemetry devices 103 can also respond to status (e.g., of position, speed, digital I/O port status, analog input channel status, peripheral status or other device status) queries transmitted by the NOC 101. The status query may request either current status or status within a time and date range. The device 103 responds to the query with either the current status or all status within the date and time range that is currently stored in the device's data log.

As regards data logging, the devices 103 support use of one or more schedules for the data acquisition. The data logging involves storing of the data locally on the device 103. This data, which can include position, speed, digital I/O port status, analog input channel status, peripheral status or other device status, is not automatically transmitted over the air. Instead, the data is stored for a finite period of time and made available for use by scheduled data acquisitions, data acquisitions on demand, and data acquisitions associated with alerts. The data log is circular in that when the last available memory for the data logger has been written, the data logger begins recording new data at the first location of memory available for the data logger.

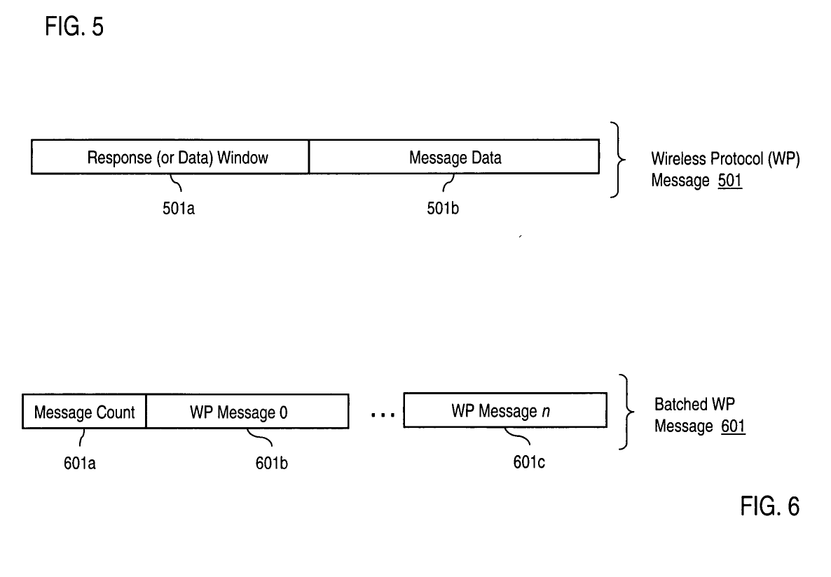

With scheduled acquisitions of the data collected by the data logger the data within the data log is transmitted by the device 103 according to a configurable schedule at the configured transmission rate. Multiple schedules may be configured on the device 103. Schedules are configured to obtain data at a regular interval based upon calendar time and date. Schedules may be configured such that they are enabled and disabled based upon status of a digital input. For example, an ignition status input may be used to turn a schedule on when the engine is on and turn the schedule off when the engine is off. A Response (or Data) Message Window value can be configured on the device 103, such that the device 103 delays sending scheduled data using an Offset within the Data Message Window (shown in FIG. 5). That is, the scheduled transmit time is adjusted by the Offset, the device 103 delays queuing the scheduled data until the time is equal to the transmit time plus the Offset. Use of the Data Message Window helps prevent overwhelming the wireless network when many devices are scheduled to transmit data at the same time. For example, it is likely that many schedules will be based upon transmitting on the hour, half past the hour, or at fifteen minute intervals. Using the Offset ensures that the scheduled data transmissions from all of the devices with similar schedules are not sent at precisely the same time. Given the precision of the telemetry device's clock (as it is based upon GPS time), this randomization of regularly scheduled device transmissions is particularly useful.

As mentioned previously, the telemetry devices 103 can be configured to monitor a variety of information relating to the vehicle or asset through the digital I/O and analog I/O. For instance, alerts can be used to indicate status change of the digital inputs. Each Digital Input Status Change Alert can be enabled and disabled through configuration. The alert may be configured to transmit other device status recorded at the time of the alert such as position, speed, status of other digital I/O ports, analog input status, peripheral status, or other device status. As regards the digital output, the status of each available digital output can be changed or read.

Similarly, the statuses of analog inputs of the devices 103 are monitored for change. In an exemplary embodiment, multiple threshold levels (e.g., high and low) can be set, whereby alerts are generated (e.g., Low Range Entry alert, Low Range Exit, High Range Entry, and High Range Exit). That is, if the value of the Analog Input falls below the Low Threshold, a Low Range Entry Alert is generated. If the value of the Analog Input rises above the Low Threshold, plus a Hysteresis value, a Low Range Exit Alert is generated. In similar fashion, if the value of the Analog Input rises above the High Threshold, a High Range Entry Alert is output from the device 103. Also, if the value of the Analog Input falls below the High Threshold minus a Hysteresis value, a High Range Exit Alert is generated. The alert may be configured to transmit other device status recorded at the time of the alert such as position, speed, status of other digital I/O ports, analog input status, peripheral status, or other device status.

By way of example, the devices 103 can be used to monitor excessive speed via a High Speed Alert Control, whereby a High Speed Threshold can be set by a fleet manager. In addition, a duration parameter (i.e., High Speed Duration) can be utilized to specify the time at which the High Speed Threshold must be exceeded before an alert is generated. Further, a configurable High Speed Hysteresis parameter is set as the delta change below the High Speed Threshold used to determine when the High Speed Threshold has no longer been exceeded. The alert may be configured to transmit other device status recorded at the time of the alert such as position, speed, status of other digital I/O ports, analog input status, peripheral status, or other device status.

The system 100 also permits users via the hosts 109 to specify and configure areas of interest within the coverage area of the network 101 such that alerts can be generated when a device 103 enters or exits the configured areas. The alert may be configured to transmit other device status recorded at the time of the alert such as position, speed, status of other digital I/O ports, analog input status, peripheral status, or other device status.

The data collected and transmitted by the telemetry devices 103 are processed by the NOC 101, the components of which are described in FIG. 3.

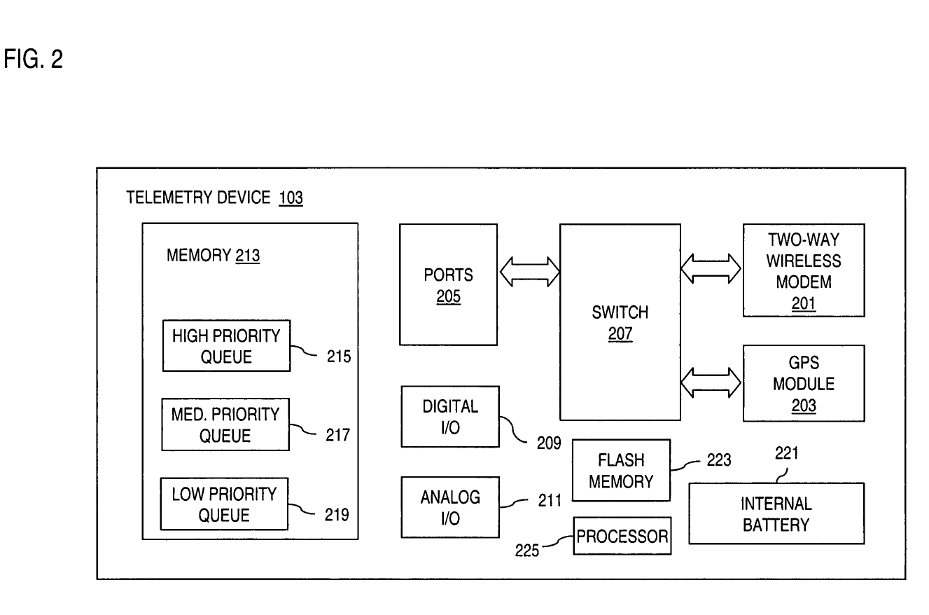

FIG. 2 shows a diagram of a telemetry device used in the system of FIG. 1, according to an embodiment of the present invention. The telemetry device 103, which can be deployed within a vehicle (as shown in FIG. 1 or coupled to any asset), operates within the wireless network 107. By way of example, the components of the telemetry device 103 are described in the context of a narrowband network, such as a paging system; however, it is contemplated that the components for communications can be tailored to the specific wireless network.

In this exemplary embodiment, the telemetry device 103 includes a two-way wireless modem 201 for receiving and transmitting signals over the wireless network 107 according to the communication protocols supported by the wireless network 107, such as the Motorola ReFLEX™ protocol for two-way paging. By way of example, a Karli ReFLEX™ module by Advantra International can be used for the modem 201. The two-way wireless modem 201 couples to a two-way wireless antenna (not shown) that can be placed local to the device 103 or remote from the device 103 (e.g., 12 or more feet) to enhance flexibility in installation.

The telemetry device 103 also contains a GPS module 203 that is capable of operating in the multiple GPS modes: autonomous GPS mode, and mobile-based A-GPS mode. The GPS module 203 can employ, for example, a GPS receiver manufactured by FastraX-iTrax02/4. In autonomous mode, GPS data may be acquired with no assistance data provided by the wireless network 107. The GPS module 203 operates in the A-GPS mode when the device 103 is in wireless network coverage, in which assistance data is supplied and can include ephemeris data and data to obtain location in obstructed view locations (in building, wooded areas, etc.). Further, the assistance can include differential GPS (DGPS) to enhance location accuracy under some conditions. The GPS module 203 couples to a GPS antenna (not shown) that can be placed local to the device 103 or remote from the device 103 (e.g., 12 or more feet) to enhance flexibility in installation.

Attachment of peripheral modules to the telemetry device 103 is supported by one or more peripheral ports 205. The ports 205, for example, can be used to connect to intelligent peripherals that operate according to business rules and logic. These business rules and logic can be housed in a vehicle harness (not shown), which include an On-Board Diagnostic (OBDII) interface and intelligence. Under this arrangement, a user (e.g., fleet manager) can query any parameter available through the OBDII interface. For example, data obtained for each tracking record can include any combination of the following items: RPM (Revolutions Per Minute), oil pressure, coolant temperature, etc. Such data recorded by the telemetry device 103 is stored in memory 213. The acquisition period for the data is configurable, as well as the transmission interval to the NOC 101. Furthermore, the monitoring and subsequent data exchange can be governed by a configurable schedule, which can specify such parameters as start date, start time, end time, recurrence (e.g., daily, weekly, monthly, etc.), and duration.

Data is logged by a data logger 207, made available for use by scheduled data acquisitions, data acquisitions on demand, and data acquisitions associated with alerts. As mentioned, the telemetry device 103 also can be configured to include digital I/O 209 and analog I/O 211 for monitoring and control of the vehicle or asset. The data logger 207 also collects data associated with these I/O ports 209, 211.

The telemetry device 103 also includes a processor 225 that may handle arithmetic computations, and may support operating system and application processing. The processor 225, while shown as a single block, may be configured as multiple processors, any of which may support multipurpose processing, or which may support a single function.

The memory 213 of the telemetry device 103 can be organized to include multiple queues for prioritizing the messages to be processed by the device 103. In an exemplary embodiment, the memory 213 includes a High Priority queue 215, a Medium Priority queue 217, and Low Priority queue 219. The memory 213, while shown as a single block, may be configured as multiple memory devices, any of which may support static or dynamic storage, and may include code for operating system functionality, microcode, or application code.

Data recorded by the telemetry device 103 may additionally be stored in a storage medium other than the prioritized queues 215, 217, and 219, such as in a flash memory 223. A log (not shown) of information may be kept so that the information may be transmitted according to a schedule, as discussed above, or, e.g., upon receipt of a request to send all data that has been collected. Storage devices have only a finite amount of space for storage of information, and thus the information for only a finite number of messages may be stored in either the prioritized queues 215, 217, 219 or the flash memory 223.

In an exemplary embodiment, information collected, e.g., for up to a 72-hour period may be stored in a log in the flash memory 223. The information may be stored in the log as elements in a queue, in which the information elements are processed according to a first-in-first-out scheme.

To improve availability of the telemetry device 103, an internal battery 221 is optionally included. With the internal battery, the telemetry device 103 can continue to monitor and transmit alerts and status information to the NOC 101 even if the electrical system of a vehicle is inoperable. Additionally, the internal battery 221 can be used by the device 103 to gracefully report power status wirelessly and shut down gracefully when the energy level of the internal battery is becoming too low to sustain operation of the device.

The functions of the NOC 101, which interacts with the telemetry devices 103 to exchange information for supporting fleet and asset management, are detailed with respect to FIG. 3.

FIG. 3 shows a diagram of a Network Operations Center (NOC) in the system of FIG. 1, according to an embodiment of the present invention. The NOC 101 utilizes, in this exemplary embodiment, a client-server architecture to support the telemetry devices 103. Specifically, the NOC 101 houses a messaging server 301 for sending and receiving messages to the devices 103 over the air, for storing the messages, and routing these messages to their destination. The NOC 101 provides connectivity via a local area network (LAN) (not shown) for the messaging server 103 with an A-GPS server 303, a routing server 305, and a gateway 307. The gateway 307 communicates a with a security server 309 to support encryption and decryption of the messages. A presentation server 311 resides within the NOC 101 to interface with the data network 111 (e.g., the global Internet), such that the host 109 can access the services of the fleet and asset management system. The host 109 under this scenario is loaded with a desktop client 313.

Although a single server is shown for the presentation server 311, in the alternative, the server 311 can functionally be implemented as three separate servers: a database server, a middleware server, and a web server. The database server is responsible for data storing, data updating, and data retrieval as well as providing a set of interfaces to achieve these functions. The web server is responsible for serving maps, presenting user interfaces to manage and control user administration, device configuration, and etc. The middleware server can be deployed between the database server and the web server, and has the following responsibilities: 1) converting the web server's data retrieval requests to database server APIs and then sending to database server, 2) receiving the responses from the database server and then sending back to web server, 3) receiving data from gateway 307 and then sending requests to the database to store/update data records. Because of the modularity in this design, these three components can reside on the same machine, as shown in FIG. 3, or reside in multiple platforms.

Messages from the telemetry devices 103 are forwarded by the messaging server 301 to either the A-GPS server 303 or the routing server 305. If the message is an assist request, this message is sent to the A-GPS server 303. In response to the GPS assist request, the A-GPS server 303 determines GPS assistance data for transmission to the requesting telemetry device 103.

The A-GPS server 303 obtains ephemeris data from the GPS reference network 113, and determines satellite configuration for each of the geographic zones comprising the wireless network. The A-GPS server 303 also determines the assistance data for each geographic zone. The NOC 101 then periodically broadcasts the assistance data to each geographic zone. In addition, the A-GPS server 303 supplies GPS assistance data to any telemetry device 103 that requests the GPS assistance data. When supporting this request, the NOC 101 determines approximate location of the requesting device 103 (based upon base receivers that received the request, using a type of triangulation. Subsequently, a GPS Assistance message is generated by the A-GPS server 303 to send to the telemetry device 303 based upon its approximate location. The messaging server 301 sends the GPS Assistance message to the particular telemetry device 103.

Thus, the A-GPS server 303 delivers GPS assistance data through two mechanisms by periodically broadcasting GPS assistance data to all devices 103 in each of the geographic zones covered by the wireless network 107, or by responding to specific requests by the telemetry devices 103 for GPS assistance data.

The routing server 305 has responsibility for routing of the messages from the telemetry devices 103, and managing such messages from the devices 103 to their server destinations. Each device 103 can be configured to have messages directed to one or more destination servers. The routing server 305, upon receiving message from a telemetry device 103, determines a destination address that has been configured for the device 103 and modifies the destination address accordingly. The message is then forwarded to the configured destination. By default, the messages are directed to the gateway 307.

The gateway 307 interfaces with the presentation server 311 to permit the desktop client 313 access to the fleet and asset management system. The gateway 307 provides translation of wireline messages and commands from the presentation server 311 to the wireless protocol for communication with the telemetry devices 103. For example, the gateway 307 supports an extensible Markup Language (XML) interface, such that XML commands submitted to the gateway 307 over wireline are converted to the wireless protocol commands and sent over the paging network 107 to the devices 103. In turn, the wireless protocol messages received from the devices 103 are converted to wireline XML messages. The gateway 307 provides translation of wireline messages and commands from the host 109 to the wireless protocol for communication with the telemetry devices 103. In turn, the wireless protocol messages received from the devices 103 are converted to wireline XML messages and sent to host 109.

The presentation server 311 provides the following functions: fleet and asset tracking, and general purpose I/O monitoring and control. The server 311 also maintains a database (not shown) for user accounts and other related data (e.g., configuration data, user management information, device management, and data acquired from the devices 103). The presentation server 311, as mentioned, also generates the maps corresponding to where the devices 103 are tracked and the mapping preferences configured. Using the desktop client 313, a user can even issue requests to command a particular device 103, such as requesting location of the device 103.

With the presentation server 311 as a front end, a user via the desktop client 313 can configure the telemetry devices 103 via web interfaces. In an exemplary embodiment, the server 311 is a World Wide Web (“web”) application server to support a web browser based front-end for the desktop clients 109. The web application server (not shown) can be deployed to support such web interfaces as a set of Java Server Pages (JSP) and Java Applet to interact with the user on the desktop client 313. On the backend, based on data collected by JSP and Java Applet, the web server can generate the proper XML commands that are compliant with Application Programming Interface (API) of the presentation server 311. Consequently, the collected records can be stored in the database of the presentation server 311. The database also stores the properties of the telemetry devices 103, such as the alerts and thresholds earlier described.

The desktop client 313 interfaces to the system 100 through the presentation server 311. From the desktop client 313, the user logs in to the system 100. The presentation server 311 can also perform authentication as well as administration tasks such as adding new users or devices 103. The user can also configure business rules executed by the presentation server 311, wherein the business rules logic uses this user supplied configuration to configure the devices 103, acquire, and process data from the devices 103.

Additionally, the presentation server 311 provides a reporting capability based on the stored information in the database. The presentation server 311 can support standard reports or customize reports to the user via the desktop client 313.

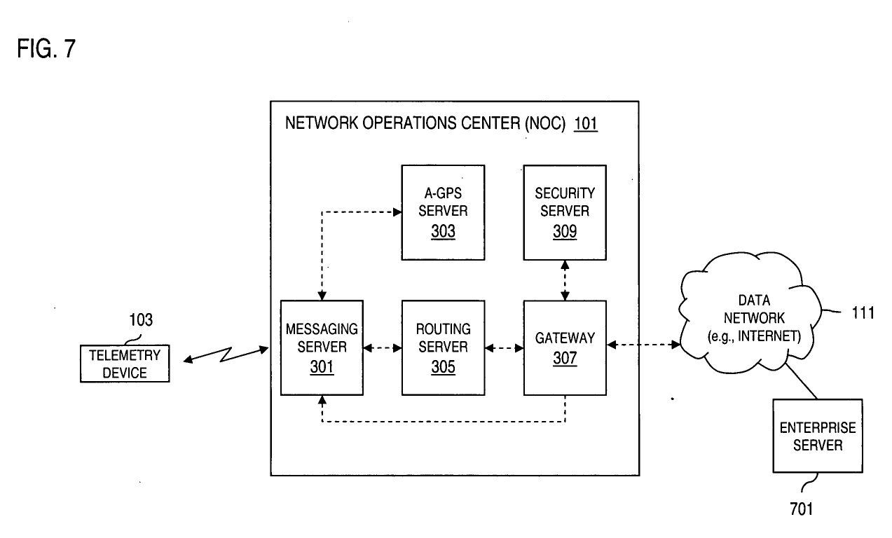

Instead of using a desktop client 313, the user, if associated with a large organization, can utilize an enterprise server to obtain all of the user functionality through the gateway 307 using the API of the fleet and asset management system 100. Accordingly, the enterprise server would possess the functional capabilities of the presentation server 311, but would be managed by the customer (or user) at the customer's premise, as shown in FIG. 7.

As noted, the wireless protocol supports communications between the NOC 101 and the telemetry devices 103. In an exemplary embodiment, the messaging is performed according the FLEXsuite Uniform Addressing & Routing (UAR) protocol (developed by Motorola). The wireless protocol message, which can be encapsulated with an UAR message, is unencrypted.

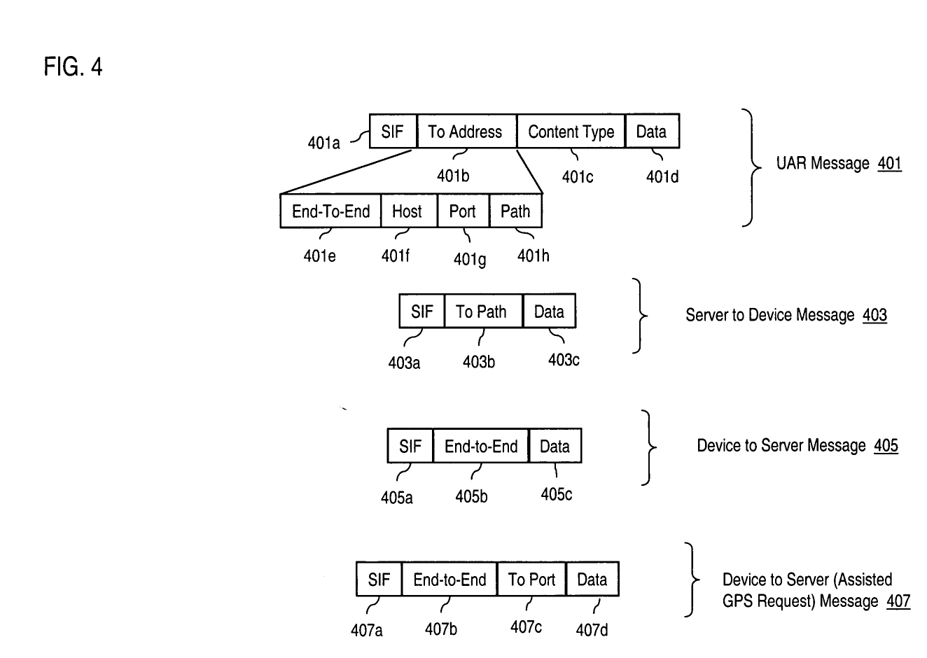

FIG. 4 shows a diagram of the formats of protocol messages used in the system of FIG. 1. By way of example, the protocol is the UAR protocol. Accordingly, a UAR message 401 includes the following fields: a Status Information Field (SIF) field 401a, a Destination Address (“To Address”) field 401b, a Content Type field 401c, and a Data field 401d. Table 1, below, defines these fields 401a-401c.

TABLE 1

| Field | Definition | Data Type | Size |
|---|---|---|---|
| SIF | Identifies the application | Integer | 8 bits |
| | protocol used to encode | | |
| | the remaining data in the | | |
| | message; indicates UAR | | |
| | addressing is used | | |
| To | Destination Address | UAR “To | Variable |
| Address | | Address” Encoding | |
| Content | Identifies the format of | UAR Content | 24 bits |
| Type | the attached Data | Type | |
| Data | UAR format data payload | UAR data | Variable |

With respect to the “To Address” field 401b, this address can be further specified the following fields: an End-To-End field 401e, a Host field 401f, a Port field 401g, and a Path field 401h. The End-To-End field 401e is utilized for device to server routing. It is noted that no addressing is needed for device to server routing with the exception of an Assisted GPS Request message. Because the routing server 305 controls message routing from the telemetry device 103, some of the address information requirement is specific to UAR. Path Addressing, per the Path field 401h, is used for server to device routing, as in the case, for example, addressing of a peripheral device attached to the telemetry device 103. As shown in FIG. 4, for server to device messaging, message 403 can be used and includes a SIF field 403a, a To Address field 403b specifying the path, and a Data field 403c. A device to server message 405 utilizes a SIF field 405a, a To Address field 405b specifying the End-to-End address, and a Data field 405c. In the case of a device to server transmission relating to acquisition of Assisted GPS (e.g., in form of an Assisted GPS request), a message 407 is provided, and includes a SIF field 407a, a To Address field specifying the End-to-End address 407b and Port 407c, and a Data field 405c.

As regards UAR messages in general, the Data field 401d contains binary formatted data, which is the unencrypted Wireless Protocol (WP) message (as described in FIGS. 5 and 6).

FIG. 5 shows a diagram of the format of a Wireless Protocol (WP) message used in the system of FIG. 1. A Wireless Protocol message 501 includes a Response Window (or Data Window) field 501a to regulate the over-to-air transmission of the message from the telemetry device 103 to the NOC 101, as described previously. In other words, with the telemetry devices 103, accommodation is made to support staggering of device responses to prevent overwhelming the reverse path of the wireless network 107 (FIG. 1) if a command is sent to a large number of devices in a broadcast message. The Response Window field 501a is thus used to specify a desired time frame for obtaining responses from deployed devices 103. If a Response Window is specified in a message, the device 103 delays sending its response using an Offset value within the Response Window when responding to the message. That is, after first processing the message, the device 103 delays sending the response to the message until the Offset time has expired. To ensure a good distribution of responses during the Response Window, the device 103, in an exemplary embodiment, can randomly select an Offset time within the specified time window.

The message 501 also provides a Message Data field 501b for specifying the data (such as data within the data log, and alerts).

According to one embodiment of the present invention, the NOC 101 can batch the WP messages 501 to reduce overhead, resulting in a batched message 601. The batched message 601 specifies a Message Count field 601a to indicate the number of WP messages 501 (0 . . . n, where n is an integer) that are contained within the batched message 601. The WP Message fields 601b, 601c pertain to the corresponding messages specified by the Message Count value in the field 601a. The messages of FIGS. 5 and 6 support a number of transactions between the NOC 101 and the telemetry device 103. For example, server transactions involve a request being sent from a server (e.g., servers 301, 303, and 305) to the device 103 and a response sent from the device 103 to the server. For instance, in a Device Configuration Request from the NOC 101 to the device 103, the information enumerated in Table 6 is transmitted.

FIG. 7 shows a diagram of a Network Operations Center (NOC) in the system of FIG. 1, according to an embodiment of the present invention. An enterprise approach eliminates the need for the presentation server 311 in the NOC 101. An enterprise server 701 communicates directly with the gateway 307 over the data network 111. This architecture advantageously provides the customer with greater flexibility in developing applications for the fleet and asset management system 100.

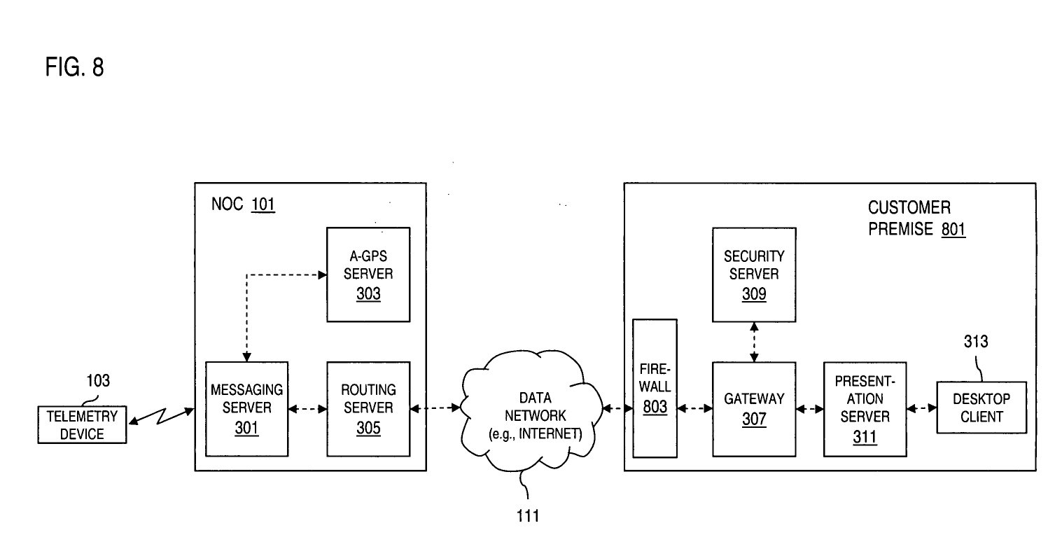

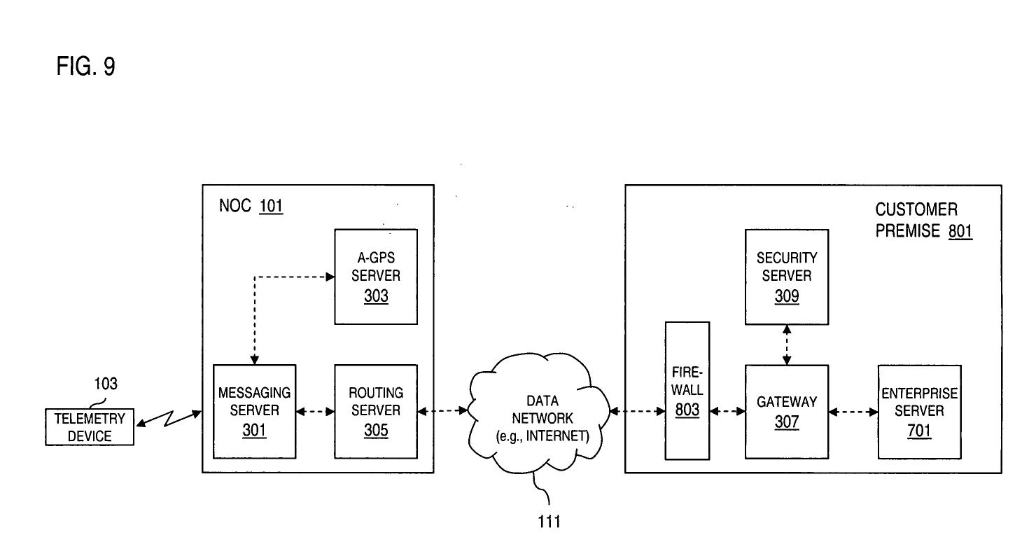

The discussion thus far of the fleet and asset management system 100 has provided security from the telemetry devices 103 to the NOC 101 through use of the security server 309 resident within the NOC 101. In the alternative, end-to-end encryption can be supported by situating the security server at the customer premise, as described in FIG. 8 and FIG. 9.

FIG. 8 shows a diagram of a fleet and asset management system with end-to-end encryption, according to an embodiment of the present invention. Under this architecture, a customer premise 801 houses the security server 309, the gateway 307, and the presentation server 311. The presentation server 311 operates with the desktop client 313 as detailed with respect to FIG. 3. In this example, a firewall 803 is implemented between the data network 111 and the gateway 307; this added security feature eliminates any potential gaps in security at the NOC that occurs when decrypting the wireline message and re-encrypting the wireless message.

FIG. 9 shows a diagram of a fleet and asset management system with end-to-end encryption in an enterprise environment, according to an embodiment of the present invention. In this scenario, the customer premise 801 does not house the presentation server 311 that communicates with the desktop client 313, but instead includes the enterprise server 701.

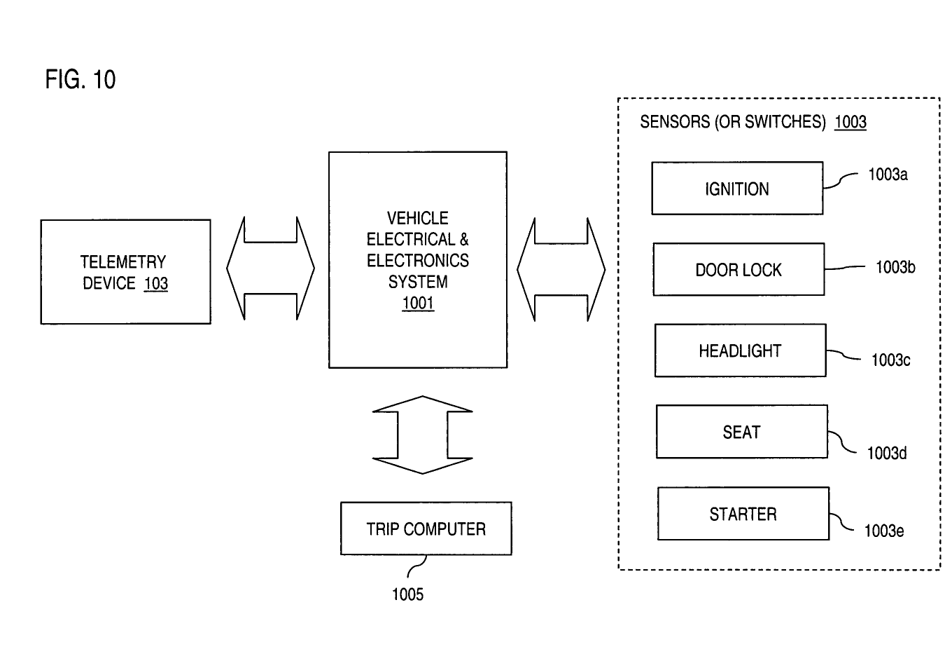

FIG. 10 is a diagram of the telemetry device of FIG. 2a deployed within the vehicle, according to an embodiment of the present invention. In this exemplary scenario, the telemetry device 103 interfaces with a vehicle electrical and electronics system 1001 to obtain data relating to a variety of environmental and diagnostic information. For instance, the vehicle electrical and electronics system 1001 can include electrical sensors (or switches) 1003 deployed through the vehicle. These sensors 1003 can relay information regarding status of the following: ignition 1003a, door lock 1003b, headlight 1003c, seat occupancy 1003d, and starter 1003e. Also, the system 1001 can include a trip computer 1005 that records information regarding, for example, speed, average speed, distance traveled, fuel level, fuel economy, distance to empty fuel tank, RPM, coolant temperature and level, oil pressure, alternator and brakes, battery voltage, windshield washer fluid level, ambient temperature, cargo temperature, and outside temperature. The data relating to the system 1001 is collected by the telemetry device 103 within its prioritized queues and data log and made available to the NOC 101.

This process of data collection and subsequent transmission to the NOC 101 can be triggered according a configurable schedule. Moreover, the schedule can be activated or deactivated based upon status of an input/output 209, 211, such as ignition On/Off state.

Although the above discussion involves the telemetry device 103 collecting data in an automotive context, it is recognized that data relating to any asset can be gathered.

FIG. 11 is a flowchart of a process for supporting supervisory or parental control via a web interface, according to an embodiment of the present invention. The system 100, in an exemplary embodiment, can support a supervisory or parental control service, whereby the driving behavior of a teenage driver can be tracked and analyzed. In step 1101, the NOC 101 monitors and collects telemetry data of the vehicle driven by the teenage driver. The data, according to one embodiment of the present invention, is stored, as in step 1103, and made accessible via a web server (e.g., the presentation server 311). A supervisory user (e.g., parent or guardian) then accesses, per step 1105, the presentation server 311 using a web interface (e.g., web browser) resident on the desktop client 313. The web pages can be generated using, in an exemplary embodiment, dynamic hypertext markup language (DHTML). DHTML encompasses a combination of technologies, including HTML, style sheets, and Java Script, to provide animated web pages—notably, a “rubber-band” mechanism for zooming.

Among other options, the server 311 can offer the following choices: (1) View Position, (2) Vehicle Control, (3) Define Zones, and (4) View Analysis of Historical Data. The user can then select anyone of the options via the web interface, per step 1109. For instance, under the View Position option, the user is presented with a view of the present location of the vehicle as well as all the locations visited by the teenage driver within configurable period (e.g., past nine days). With option (2), the parent can enforce restrictions on use of the vehicle by disabling the starter if the teenage driver has been grounded or if the vehicle has been stolen. In addition, this service can provide the parental user with the capability to assist the teenage driver if the teenage driver is locked out of the vehicle by controlling the door locks in the vehicle. As will be more fully described, the restrictions can be based on geographic zones, time of day, etc. These geographic zones are created under option (3). By selecting option (4), the user can view the history of where their teenage driver has visited, and analyze data (in text or graphical form) the speeding habits of the teenager driver.

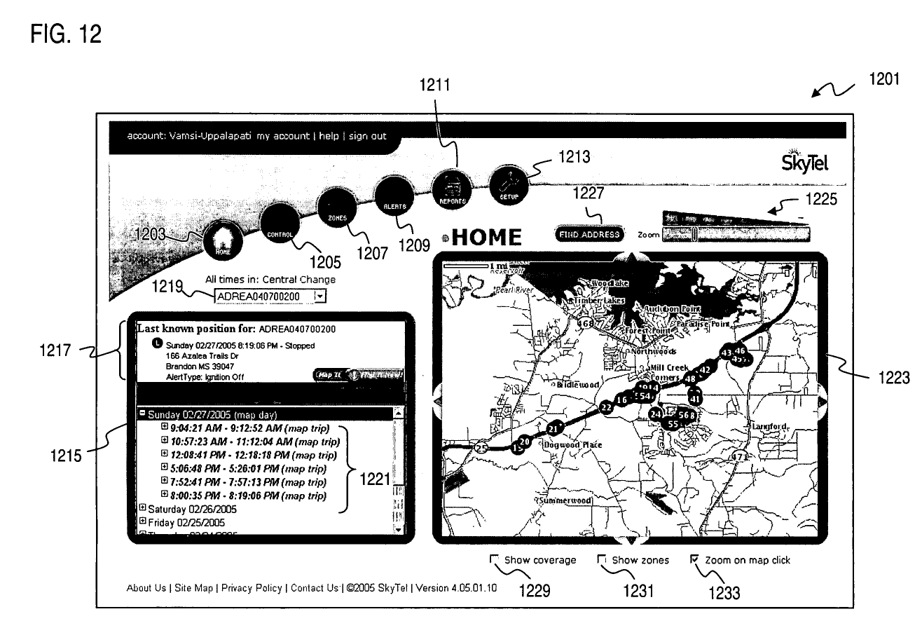

Exemplary graphical screens of the parental control service are illustrated in FIGS. 12-15.

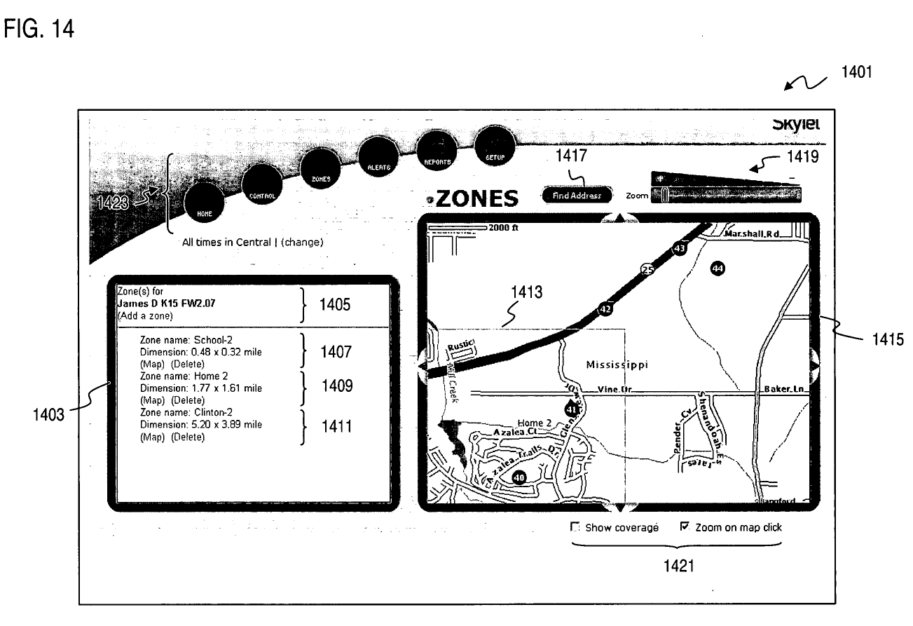

FIG. 12 is a graphical screen displaying locations visited by a tracked vehicle, according to an embodiment of the present invention. The user interface allows the user to program and track the telemetry device installed in a teenager driver's vehicle. A graphical user interface (GUI) screen 1201 includes a variety of menu/navigation buttons 1203-1213 to other GUI screens. The home button 1203 returns to a home page. The control button 1205 provides the user with a capability to control various functions of the vehicle. For example, the user can unlock the vehicle door if the driver has left the key inside the vehicle, or disable the ignition if the parental user does not want the vehicle to be moved. The zones button 1207 provides a web page (e.g., as shown in FIG. 14) for defining geographic zones. The alerts button 1209 permits the user to specify and define the types of alerts that the user seeks to be notified of. The report button 1211 provides a web page for generating various reports relating to the telemetry data of the vehicle. Such reports can include predetermined reports as well as customizable ones. The screen 1201 also allows the user to define various user preferences for the web interface using the setup button 1213.

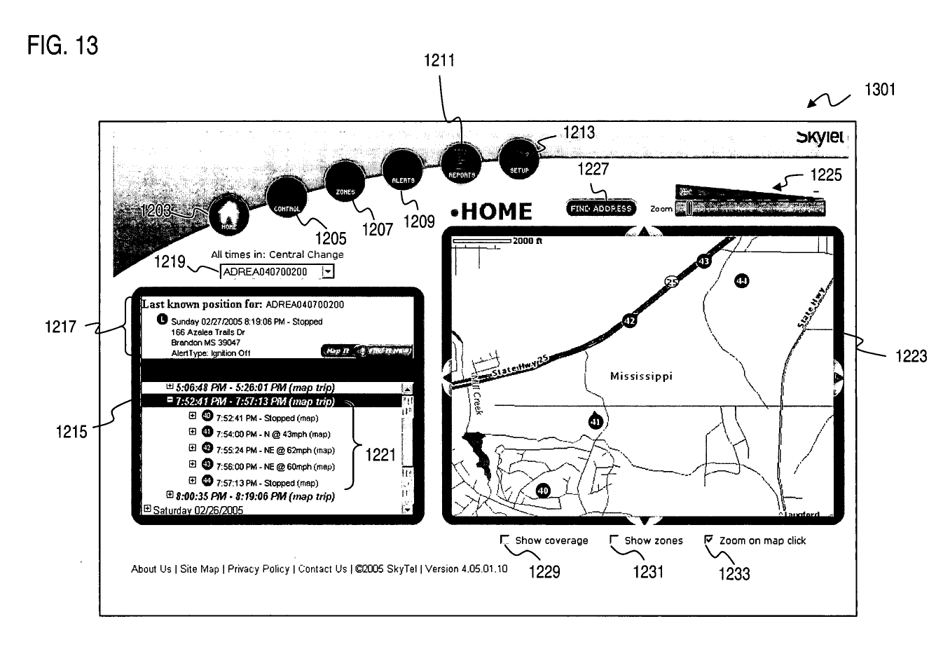

As shown, a window box 1215 contains a text area 1217 that displays the current or last known position for the driver. In this example, the vehicle is identified with the following ID: “ADREA040700200.” This ID can be specified by the user using the text box 1219, as it is contemplated that a single user account can have multiple vehicles, thus, require multiple IDs. Within the window box 1215, the text area 1221 lists the days of the weeks and associated time intervals. The user can select any day and time interval to view the “trips” of the driver. In an exemplary embodiment, a trip can be defined based on a time interval. For instance, the time interval can be set by triggering events such as an “ignition on” alert and an “ignition off” alert. It is contemplated that other definitions can be used based on geographic points (e.g., start and stop points). The trips shown in the text area 1221 correspond to icons (shown as numbered points or circles) on the map 1223, indicating the location of the vehicle. This exemplary screen 1201 shows the parents the trips that were taken by the driver of the vehicle on Sunday, February 27^{th}. Each trip can be expanded to show more details, such as exact location, travel direction and speed of the vehicle, as shown in FIG. 13. Other telemetry data can also be provided.

With respect to the map area 1223, a zoom bar 1225 allows for a close up of map. As will be described later, the user can also zoom on the map by utilizing a “rubber-band” box feature. Additionally, a Find Address button 1227 is provided in which the user can supply an address and have that location displayed on the map area 1223. Further, a Show Coverage check box 1229 permits to user to view the coverage area of the system 100. A Show Zones check box 1231, when selected, would visually display all the geographic zones defined for the vehicle. A Zoom on Map Click check box 1233 is shown as selected, and thus, provides a capability to zoom on any point in the map.

FIG. 13 is a graphical screen for viewing details of a location visited by the vehicle, according to an embodiment of the present invention. Upon selecting a time interval within the text area 1221, the user within screen 1301 can view the map of the trips of the vehicle during this period. In this example, the parental user selects the time interval “7:52:41 PM-7:57:13 PM,” resulting in an expanded text description showing data points 40-44 that were collected during the specified time interval. Each of the numbered entries provides the direction and speed of the vehicle. Assuming a speed limit of 55 Mph (Miles Per Hour), the parent can note that the driver exceeded the speed limit at points 42 and 43, in which the vehicle was traveling at 60 Mph and 62 Mph. In addition to active inquiry by the parental user, the user can be automatically notified with alerts when the vehicle exceeds the speed limit.

Furthermore, the system 100 affords the parental user with the capability to set a geographic area or “zone” whereby the vehicle must stay within or must not enter to avoid triggering alerts. Such zones can be created easily, as next explained.

FIG. 14 is a graphical screen for viewing and creation of geographic zones, according to an embodiment of the present invention. To enter the Zone creation screen 1401, the user selects the zone button 1207 (of FIG. 12). The window box 1403 now displays a text area 1405, which specifies the zones for a particular user ID, e.g., “James D K15 FW2.07.” The window box 1403 also enumerates the zones that are defined for this user in text areas 1407, 1409 and 1411. Under this scenario, three zones are defined: School-2, Home 2, and Clinton-2. Each of the zone entries includes area information; in this example, is specified in square miles.

At any time, the user can create additional zones by clicking on the “(Add a zone)” text in the text area 1405. This activates a cursor to support a “rubber-band” feature to define the zone. By way of example, a zone creation area 1413 is in form of a rectangle (or square) and can be moved about the map 1415. With the movement of the cursor controller such as a mouse or keyboard cursor keys, the user can readily size and resize the zone creation area 1413. It is contemplated that the zone creation area 1413 can be in other geometric forms, such as circular, elliptical, polygonal, etc.

As with the graphical screen 1201 of FIG. 12, the zone screen 1401 also includes a Find Address button 1417 as well as a Zoom bar 1419 to scale the map. Check boxes 1421 are also used relating to “Show coverage,” and “Zoom on map click” functions. Further, menu/navigation buttons 1423 are provided.

As mentioned, the web interface, according to an embodiment of the present invention, supports a rubber-band zoom feature. This feature is active any time a graphical map is provided by the interface.

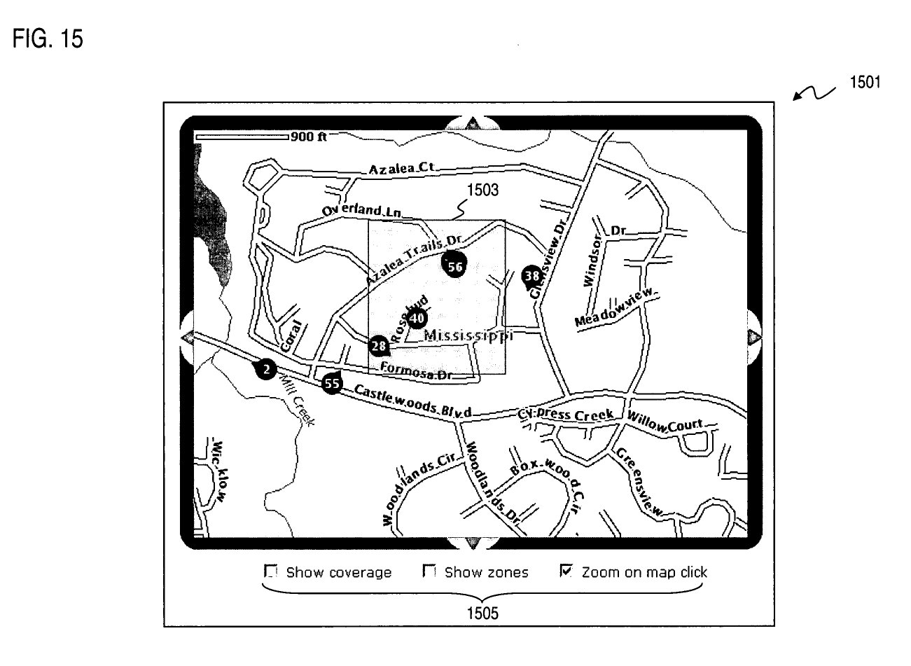

FIG. 15 is a graphical screen providing a rubber-band zoom capability, according to an embodiment of the present invention. A map screen 1501 can be provided with a multitude of graphical screens, such as screens 1201, 1301 and 1401. A selection area 1503 permits the user to select the area to be zoomed based on a rubber-band feature. The user can drag and drop the selection area 1503 any where on the map. As with screen 1201, check boxes 1505 relating to the map are also provided: Show Coverage, Show Zones, and Zoom on Map Click.

Although the selection area 1503 is rectangular in shape, other geometric shapes can be defined (e.g., circular, elliptical, polygonal, etc.) Advantageously, the rubber-band mechanism can be implemented using standard DHTML and various other HTTP based techniques, thereby providing enhanced functionality without significant development cost.

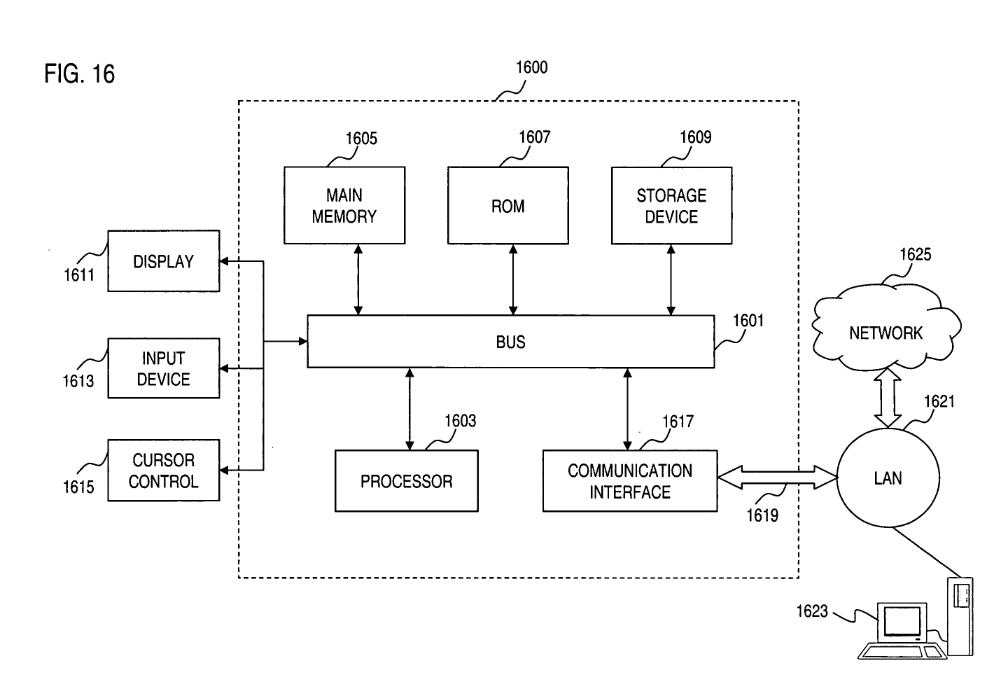

FIG. 16 illustrates a computer system 1600 upon which an embodiment according to the present invention can be implemented. For example, the client and server processes for supporting fleet and asset management can be implemented using the computer system 1600. The computer system 1600 includes a bus 1601 or other communication mechanism for communicating information and a processor 1603 coupled to the bus 1601 for processing information. The computer system 1600 also includes main memory 1605, such as a random access memory (RAM) or other dynamic storage device, coupled to the bus 1601 for storing information and instructions to be executed by the processor 1603. Main memory 1605 can also be used for storing temporary variables or other intermediate information during execution of instructions by the processor 1603. The computer system 1600 may further include a read only memory (ROM) 1607 or other static storage device coupled to the bus 1601 for storing static information and instructions for the processor 1603. A storage device 1609, such as a magnetic disk or optical disk, is coupled to the bus 1601 for persistently storing information and instructions.

The computer system 1600 may be coupled via the bus 1601 to a display 1611, such as a cathode ray tube (CRT), liquid crystal display, active matrix display, or plasma display, for displaying information to a computer user. An input device 1613, such as a keyboard including alphanumeric and other keys, is coupled to the bus 1601 for communicating information and command selections to the processor 1603. Another type of user input device is a cursor control 1615, such as a mouse, a trackball, or cursor direction keys, for communicating direction information and command selections to the processor 1603 and for controlling cursor movement on the display 1611.

According to one embodiment of the invention, the processes of the servers and clients in the system 100 of FIG. 1 are performed by the computer system 1600, in response to the processor 1603 executing an arrangement of instructions contained in main memory 1605. Such instructions can be read into main memory 1605 from another computer-readable medium, such as the storage device 1609. Execution of the arrangement of instructions contained in main memory 1605 causes the processor 1603 to perform the process steps described herein. One or more processors in a multi-processing arrangement may also be employed to execute the instructions contained in main memory 1605. In alternative embodiments, hard-wired circuitry may be used in place of or in combination with software instructions to implement the embodiment of the present invention. Thus, embodiments of the present invention are not limited to any specific combination of hardware circuitry and software.

The computer system 1600 also includes a communication interface 1617 coupled to bus 1601. The communication interface 1617 provides a two-way data communication coupling to a network link 1619 connected to a local network 1621. For example, the communication interface 1617 may be a digital subscriber line (DSL) card or modem, an integrated services digital network (ISDN) card, a cable modem, a telephone modem, or any other communication interface to provide a data communication connection to a corresponding type of communication line. As another example, communication interface 1617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1617 sends and receives electrical, electromagnetic, or optical signals that carry digital data streams representing various types of information. Further, the communication interface 1617 can include peripheral interface devices, such as a Universal Serial Bus (USB) interface, a PCMCIA (Personal Computer Memory Card International Association) interface, etc. Although a single communication interface 1617 is depicted in FIG. 16, multiple communication interfaces can also be employed.

The network link 1619 typically provides data communication through one or more networks to other data devices. For example, the network link 1619 may provide a connection through local network 1621 to a host computer 1623, which has connectivity to a network 1625 (e.g. a wide area network (WAN) or the global packet data communication network now commonly referred to as the “Internet”) or to data equipment operated by a service provider. The local network 1621 and the network 1625 both use electrical, electromagnetic, or optical signals to convey information and instructions. The signals through the various networks and the signals on the network link 1619 and through the communication interface 1617, which communicate digital data with the computer system 1600, are exemplary forms of carrier waves bearing the information and instructions.

The computer system 1600 can send messages and receive data, including program code, through the network(s), the network link 1619, and the communication interface 1617. In the Internet example, a server (not shown) might transmit requested code belonging to an application program for implementing an embodiment of the present invention through the network 1625, the local network 1621 and the communication interface 1617. The processor 1603 may execute the transmitted code while being received and/or store the code in the storage device 1609, or other non-volatile storage for later execution. In this manner, the computer system 1600 may obtain application code in the form of a carrier wave.

The term “computer-readable medium” as used herein refers to any medium that participates in providing instructions to the processor 1603 for execution. Such a medium may take many forms, including but not limited to non-volatile media, volatile media, and transmission media. Non-volatile media include, for example, optical or magnetic disks, such as the storage device 1609. Volatile media include dynamic memory, such as main memory 1605. Transmission media include coaxial cables, copper wire and fiber optics, including the wires that comprise the bus 1601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

1. A method of tracking a vehicle via a web interface, the method comprising:
displaying via the web interface a graphical user interface (GUI) screen including a map showing an icon representing position of the vehicle; and
establishing a zoom area over the map according to a rubber-band mechanism utilized by a user.

2. A method according to claim 1, further comprising:
displaying a window box that includes textual data corresponding to the position of the vehicle, wherein the textual data includes a day-of-the-week identifier corresponding to a plurality of time intervals selectable by the user; and
displaying, within the window box, a plurality of icons corresponding to telemetry data of the vehicle during the selected time interval, wherein the telemetry data includes position information and speed information, the icons being displayed on the map.

3. A method according to claim 1, further comprising:
displaying a control button corresponding to a control GUI screen for the user to control a door lock or ignition of the vehicle.

4. A method according to claim 1, further comprising:
displaying a zone button corresponding to a zone GUI screen for the user to create a zone using the rubber-band mechanism.

5. A method according to claim 4, further comprising:
displaying an alert button corresponding to an alert GUI screen for notifying the user of an alert condition relating to either position of the vehicle, position of the vehicle with respect to the created zone, or speed of the vehicle.

6. A method according to claim 1, further comprising:
displaying a reports button corresponding to a reports GUI screen for the user to generate a report corresponding to telemetry data of the vehicle.

7. A method according to claim 1, wherein the web interface includes a web browser, and the GUI screen is generated based on a HypertText Markup Language (HTML), a style sheet, and a scripting language.

8. An apparatus for communicating with a tracking system, the apparatus comprising:
a communication interface configured to communicate with a web server storing telemetry data of a vehicle monitored by the tracking system, wherein the telemetry data includes position of the vehicle;
a display configured to display a graphical user interface (GUI) screen including a map showing an icon representing the position of the vehicle; and
a cursor control mechanism controlled by a user and configured to establish a zoom area over the map according to a rubber-band mechanism.

9. An apparatus according to claim 8, wherein the GUI screen includes a window box that includes textual data corresponding to the position of the vehicle,
wherein the textual data includes a day-of-the-week identifier corresponding to a plurality of time intervals selectable by the user,
wherein the window box shows a plurality of icons corresponding to the telemetry data of the vehicle during the selected time interval, wherein the telemetry data includes speed information, the icons being displayed on the map.

10. An apparatus according to claim 8, wherein the GUI screen includes a control button corresponding to a control GUI screen for the user to control a door lock or ignition of the vehicle.

11. An apparatus according to claim 8, wherein the GUI screen includes a zone button corresponding to a zone GUI screen for the user to create a zone using the rubber-band mechanism.

12. An apparatus according to claim 11, wherein the GUI screen includes an alert button corresponding to an alert GUI screen for notifying the user of an alert condition relating to either position of the vehicle, position of the vehicle with respect to the created zone, or speed of the vehicle.

13. An apparatus according to claim 8, wherein the GUI screen includes a reports button corresponding to a reports GUI screen for the user to generate a report corresponding to telemetry data of the vehicle.

14. An apparatus according to claim 8, wherein the GUI screen is generated based on a HypertText Markup Language (HTML), a style sheet, and a scripting language.

15. An apparatus for supporting tracking of an object associated with a telemetry device, the apparatus comprising:
means for transmitting display information for displaying interactive elements on a display device, wherein the display device is configured to display a map indicating a location of a tracked object;
means for receiving, from a user, information associated with status of the tracked object; and
means for transmitting, to the telemetry device, the status information.

16. An apparatus according to claim 15, wherein the display information supports establishing a zoom area over the map according to a rubber-band mechanism utilized by a user.

17. An apparatus according to claim 16, wherein the display information comprises:
information for displaying a window box that includes textual data corresponding to the position of the vehicle, wherein the textual data includes a day-of-the-week identifier corresponding to a plurality of time intervals selectable by the user; and
information for displaying, within the window box, a plurality of icons corresponding to telemetry data of the vehicle during the selected time interval, wherein the telemetry data includes position information and speed information, the icons being displayed on the map.

18. An apparatus according to claim 16, wherein the display information comprises:
information for displaying a control button corresponding to a control GUI screen for the user to control a door lock or ignition of the vehicle.

19. An apparatus according to claim 16, wherein the display information comprises:
information for displaying a zone button corresponding to a zone GUI screen for the user to create a zone using the rubber-band mechanism.

20. An apparatus according to claim 19, wherein the display information comprises: information displaying an alert button corresponding to an alert GUI screen for notifying the user of an alert condition relating to either position of the vehicle, position of the vehicle with respect to the created zone, or speed of the vehicle.

21. An apparatus according to claim 16, wherein the display information comprises:
information for displaying a reports button corresponding to a reports GUI screen for the user to generate a report corresponding to telemetry data of the vehicle.

22. An apparatus according to claim 16, wherein the display information is based on a HypertText Markup Language (HTML), a style sheet, and a scripting language.
